(19) United States
(12) Patent Application Publication
(10) Pub. No.: US 2014/0208997 A1
(43) Pub. Date: Jul. 31, 2014

(54) BATCH-TYPE RESISTANCE FURNACE MADE OF PHOSPHATE CONCRETE

(71) Applicants: Sergey Dmitrievich Alferyev, Seversk (RU); Valeriy Anatolievich Polyakov, Tomsk (RU)

(72) Inventors: Sergey Dmitrievich Alferyev, Seversk (RU); Valeriy Anatolievich Polyakov, Tomsk (RU)

(73) Assignee: ZAKRYTOYE AKTSIONERNOYE OBSCHESTVO "PIKKERAMA", Novosibirsk (RU)

(21) Appl. No.: 14/125,942

(22) PCT Filed: Jun. 13, 2012
(86) PCT No.: PCT/RU2012/000457

§ 371 Date: Mar. 31, 2014

(30) Foreign Application Priority Data
Jun. 15, 2011 (RU) 2011124269

(51) Int. Cl. F27D 1/00; F27D 1/14

(52) U.S. Cl. CPC F27D 1/0006; F27D 1/147
USPC 110/338

(57) ABSTRACT

The invention relates to designs for the linings and roofs of heat-engineering units for mechanical engineering and can be used in the construction of industrial furnaces in the metallurgical, heat-engineering, petroleum-processing and petrochemical industries, in the production of construction materials and in other branches of industry. The aim of the invention is to produce a strong refractory lining for resistance furnaces with a low consumption of electrical energy and a reduction in the weight and overall dimensions of the furnace. All parts of the furnace lining are formed using monolithic blocks made of high-strength refractory, electrically nonconductive phosphate concretes and are used as load-bearing construction elements. Said elements are used in resistance furnaces with an operating temperature of up to 1000° C. The technical result of the invention consists in increasing the strength of a refractory lining for resistance furnaces and reducing the electrical energy consumption, the weight and the overall dimensions of the furnace.

### FIELD OF INVENTION

The invention relates to designs for the linings and roofs of heat-engineering units for mechanical engineering and can be used in the construction of industrial furnaces in the metallurgical, heat-engineering, petroleum-processing, and petrochemical industries as well as in the production of construction materials and in other branches of industry.

### BACKGROUND OF THE INVENTION

USSR Inventor's Certificate No. 1354020, IPC F27D 11/02, describes the following design. Brackets with blocks of solid ceramic material are secured on the furnace shell in the electric resistance furnace. Hooks are mounted in the holes on the blocks, which are made of soft fibrous insulating material. The blocks are then placed on the sharpened hooks. Intermediate supports, for example, ceramic tubes, are laid between the blocks parallel to the walls of the furnace shell, mounting the hooks with clips relative to the intermediate supports. Heating elements are hung on the hooks and an electric furnace is turned on. Disadvantages of the electric furnace are the following: insufficient structural strength due to the use of additional structural fasteners and the presence of metal fasteners, which are thermal shunts.

The closest to the claimed invention is Patent RU No. 218531, IPC 7 F27D1/08, “Panel of heat-resistant concrete for lining of heat-engineering units.” A panel of refractory concrete comprises a layer of concrete and reinforcing net with embedded concrete inserts for mounting the panels, which have a longitudinal cavity on the upper base and a longitudinal protrusion on the lower base, whereby, the cavity on the upper base corresponds to the protrusion on the lower base and vice versa. The ends of the panel have a longitudinal recess. In addition, the reinforcing net with embedded concrete inserts therein is located in a concrete layer.

A disadvantage of the aforementioned construction is that the panel has a reinforcing net with embedded concrete inserts in the body of refractory concrete, which leads to the formation of thermal shunt on the surface and increases rupture stress in the concrete during thermal shifts. The application of a monolithic panel makes it necessary to increase the thickness of insulation to substantial quantities, which significantly increases the external furnace dimensions.

### SUMMARY OF THE INVENTION

The objective of the invention is to obtain a strong refractory lining for resistance furnaces with low energy consumption and a decrease in weight and overall dimensions of the furnace.

The technical result is to increase the strength of the refractory lining of resistance furnaces and to reduce energy consumption, weight, and furnace dimensions.

The batch-type resistance furnace made of refractory phosphate concrete contains interconnected blocks and the frame.

A monolithic heat-insulating block comprises two square elements that are shifted diagonally relative to each other, whereas all block sides are arranged in the form of a step and form an interlocking joint.

There are two round holes and two narrow rectangular holes in a monolithic heat-insulating block.

Spacing disks are located on the surface of a monolithic heat-insulating block, allowing an air gap to be formed between the two monolithic insulating blocks.

The heat unit comprises a monolithic square element, which has holes for mounting studs. Each of the studs mounts one heat block with internal and external heat-insulating blocks to the external structural steel furnace framing.

The furnace roof comprises a series of monolithic heat-insulating central blocks and two rows of monolithic heat-insulating support blocks, the bottom row of which is connected to a monolithic heat-insulating block that has a semicylindrical surface on the upper inner edge.

The ends of the monolithic heat-insulating support blocks are semicylindrical and are connected with semicylindrical recesses formed on the ends of the monolithic heat-insulating central block. The side edges of the monolithic heat-insulating support blocks are made in the form of a step and form an interlocking joint. The mounting studs are built in the monolithic heat-insulating central units. They are on the outer surface of the blocks and serve for mounting to an external structural steel furnace framing.

The furnace bottom comprises two rows of monolithic heat-insulating blocks connected to each other by the interlocking joint and a row of heat units. Each stud secures one heat unit and two monolithic heat-insulating blocks to the external metal bottom frame.

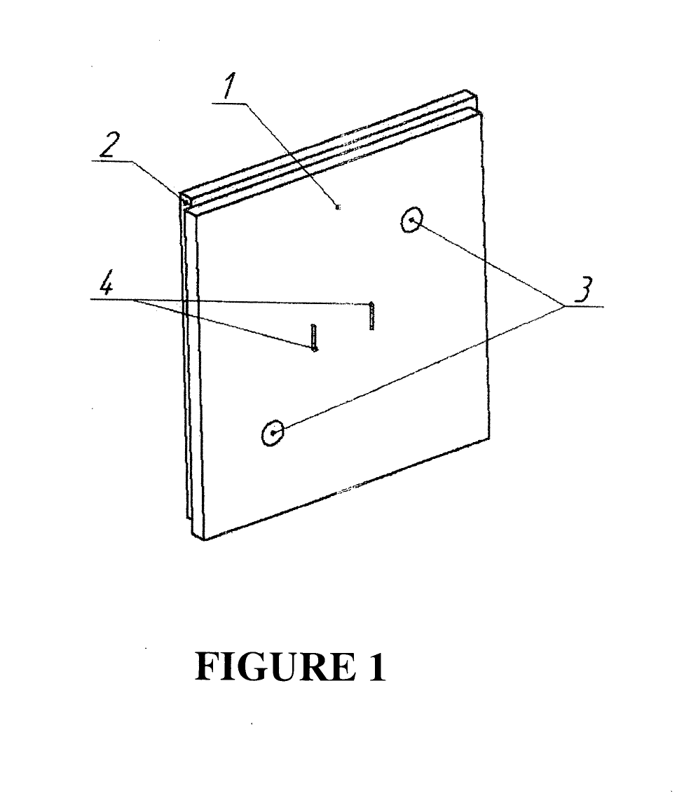

FIG. 1 shows a heat-insulating block.

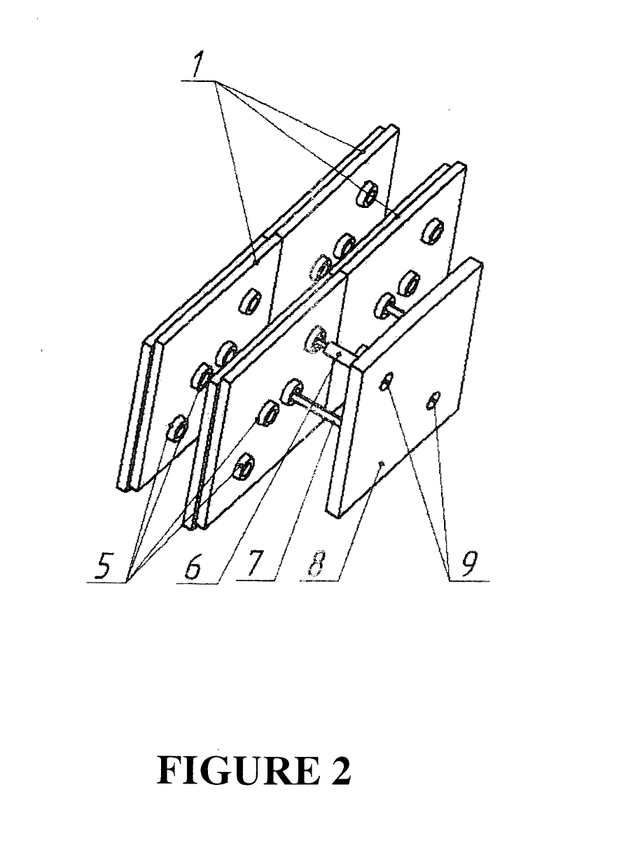

FIG. 2 shows a structural component of the batch-type furnace wall.

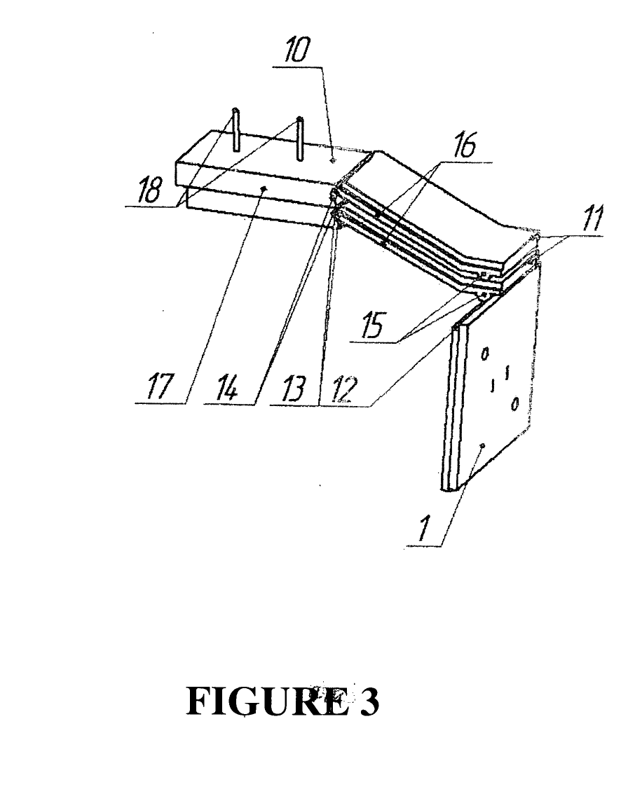

FIG. 3 shows a batch-type furnace roof.

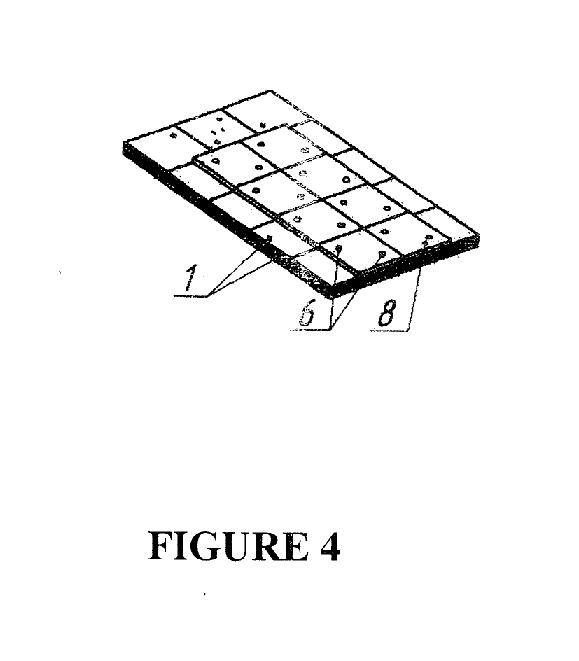

FIG. 4 shows a furnace bottom.

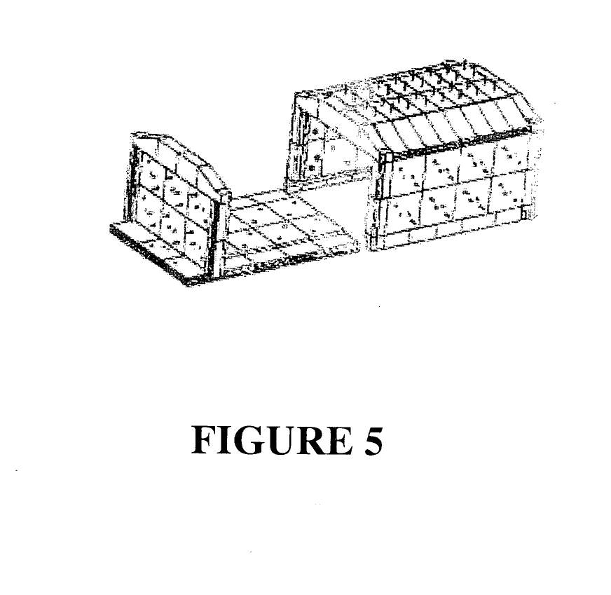

FIG. 5 shows a general view of the structure of the batch-type furnace.

A monolithic heat-insulating block 1 (FIG. 1) comprises two square elements that are shifted diagonally relative to each other, whereas all block sides are arranged in the form of a step (2) and form an interlocking joint.

Gas impermeability of welds is maintained between them by increasing the joint surface for interlocking joints, on one hand, and the surface roughness of the connecting edges, on the other hand. This leads to a lack of convection among the unit connections and to scattering energy reduction and thus to reduced energy consumption.

Two round holes (3) and two narrow rectangular holes (4) are made in the monolithic heat-insulating block (1).

The spacing disks (5) (FIG. 2) are located on the surface of the monolithic heat-insulating block (1), allowing an air gap to be formed between the two monolithic insulating blocks (1).

The main heat-insulating material is a layer of air trapped between two monolithic heat-insulating blocks (1). The spacing disks (5) provide a thermally insulating air layer between the monolithic heat-insulating blocks (1) and function as the insulation round holes (3) in which mounting studs (6) and current terminals (7) of the heat unit (8) are located, providing gas impermeability for the mounting studs (6) and current terminals (7).

The heat unit (8) comprises a monolithic square element, which has two round holes (9) for mounting studs (6).

The furnace roof (FIG. 3) comprises a series of monolithic heat-insulating central blocks (10) and two rows of monolithic heat-insulating support blocks (11), the bottom row of which is connected to a monolithic heat-insulating block (1) that has a semicylindrical surface (12) on the upper inner edge.

The monolithic heat-insulating support blocks (11) comprise semicylindrical ends (13) and are connected with semicylindrical recesses (14) of the monolithic heat-insulating central block 10 and semicylindrical protrusion (15) at the bottom of the monolithic heat-insulating support block (11). The side edges of the monolithic heat-insulating support blocks (11) are made in form of a step (16) and form an interlocking joint.

The monolithic heat-insulating central blocks (10) have semicylindrical recesses (14) at both ends for connection with two rows of the monolithic heat-insulating support blocks (11) and the side edges (17) made in the form a step in order to connect with each other.

The monolithic central insulating blocks (11) have built-in studs (18), which are located on the outer surface of the blocks and are intended for mounting the external structural steel furnace framing.

The connection of the furnace roof blocks by the semicylindrical protrusions and recesses enlarges the connection surface, increasing their gas impermeability, and gives the roof flexibility, dampening the thermal expansion of the entire roof without reducing the density of connections.

On one hand, the mounting stud is not a thermal shunt because a threaded metal stud is insulated with phosphate refractory concrete, of which the stud is made; on the other hand, the mounting stud provides a dense gastight connection with the thermal block.

The design of the bottom lining (FIG. 4) of the furnace comprises two rows of the monolithic heat-insulating blocks (1) interconnected with each other and a row of heat blocks (8) which are mounted to the external metal bottom frame with studs (6). The spacing disks are not used for the design of the furnace bottom. The compressive strength of the bottom is no lower than 50 MPa.

In the claimed design of the furnace, all parts of the furnace lining are formed using the monolithic blocks made of high refractory electrically nonconductive phosphate concrete and are used as load-bearing construction elements. Said elements are used in resistance furnaces with an operating temperature of up to 1000° C.

Surface roughness of blocks is not less than 0.63, which ensures a tight connection with the occurrence of ionic bonds and excludes the use of sealing material as a solution or refractory soft cords.

### INDUSTRIAL APPLICABILITY

The invention can be used in the construction of industrial furnaces in the metallurgical, heat-engineering, petroleum-processing, and petrochemical industries as well as in the production of construction materials and in other branches of industry.

1. A batch-type resistance furnace made of refractory phosphate concrete comprising:
interconnected blocks and a frame, a monolithic heat-insulating block including two square elements that are shifted diagonally relative to each other, whereas all sides of the blocks are arranged in the form of a step and form an interlocking joint,
the monolithic heat-insulating block including two round holes and two narrow rectangular holes, spacing disks are located on the surface of the monolithic heat-insulating block, allowing an air gap to be formed between the two monolithic insulating block,
a heat unit comprises a monolithic square element, which has holes for mounting studs, each of the studs mounts one heat block with internal and external heat-insulating blocks to the external structural steel furnace framing, the furnace roof comprises a series of monolithic heat-insulating central blocks and two rows of monolithic heat-insulating support blocks, the bottom row of which is connected to a monolithic heat-insulating block that has a semicylindrical surface on the upper inner edge, the ends of the monolithic heat-insulating support blocks are semicylindrical and are connected with semicylindrical recesses formed on the ends of the monolithic heat-insulating central block, the side edges of the monolithic heat-insulating support blocks are made in the form of a step and form an interlocking joint, the mounting studs are built in the monolithic heat-insulating central units and are on the outer surface of the blocks and serve for mounting to an external structural steel furnace framing, the furnace bottom comprises two rows of monolithic heat-insulating blocks connected to each other by the interlocking joint and a row of heat units mounted to the external metal bottom frame with studs.
